(19) United States
(12) Patent Application Publication
(10) Pub. No.: US 2007/0097331 A1
(43) Pub. Date: May 3, 2007

(54) Wide angle lens assembly for projector and an optical system having such a lens and projector

(75) Inventors: Philip M. Sadler, Cambridge, MA (US); Mary-Patricia Adamo, Framingham, MA (US); James J. Kumler, Jupiter, FL (US)

Correspondence Address: EDWARDS & ANGELL, LLP, P.O. BOX 55874, BOSTON, MA, 02205, US

(73) Assignee: Learning Technologies, Inc.

(21) Appl. No.: 11/581,959

(22) Filed: Oct. 16, 2006

Related U.S. Application Data
(60) Provisional application No. 60/726,916, filed on Oct. 14, 2005.

(51) Int. Cl. G03B 21/14

(52) U.S. Cl. 353/79

(57) ABSTRACT

Featured is a projection lens assembly including a plurality or more of optical elements, whose optical elements are configured and arranged so the configuration and arrangement substantially maintains the shape of the images being displayed throughout a hemispherical screen. That is, the optical elements are configured and arranged so to introduce a predetermined amount of distortion that substantially maintains the shape of the images being displayed on the screen from the zenith to near the edge of the field of view. Also featured are projection apparatuses and systems embodying such a projection lens assembly.

This application claims the benefit of U.S. Provisional Application Ser. No. 60/726,916 filed Oct. 14, 2005, the teachings of which are incorporated herein by reference.

### FIELD OF INVENTION

The present invention relates to wide-angle lenses and more particularly 180 deg projection lenses. The present invention also relates to optical projection systems embodying such lenses and more particularly to hemispherical optical projection systems such as systems used in planetariums.

### BACKGROUND OF THE INVENTION

Projection planetariums initially developed comprised an icosahedral projector with central light source and a multiplicity of slides, for example 32 slides, surrounding the light source, where each of the slides has its own projection lens. Images were projected onto a permanent hemispherical screen.

A portable planetarium also has been developed that provides a hemispherical screen, such as that described in U.S. Pat. No. 4,164,829. Such a portable planetarium includes a projection system or projector that generates the night sky with a single, low-power light source that illuminates cylindrical film masks, such as that described in U.S. Pat. No. 4,178,701.

The cylindrical film masks are computer generated and corrected for topology. Also the film masks are interchangeable so that a variety of images, including constellations of various cultures, components of a cell and maps of the world showing geological plates, volcano locations, wind patterns and/or ocean currents can be projected onto the portable hemispherical screen.

One limitation of existing planetariums in general is that while they can portray the image to be projected (e.g., the sky), few motions can be projected. Also, slide projectors or special effect projectors must provide additional static and moving images. While the portable planetarium described above has the flexibility to use interchangeable film masks so as to be able to change the hemispherical projection, there is a need for such a portable system to be able to provide more sophisticated motions (e.g., proper motion of the stars, views from other parts of the galaxy, geological plate motions). Presently, the display of such motions is limited to computer-generated simulations that are displayed on computer monitors or other flat screen type displays.

A projector in a planetarium use also must cover a full hemisphere and those for small planetariums, such as portable planetariums, require a full 180 deg coverage. Such coverage in small planetariums is typically achieved by the use of a “fish-eye” type of projection lens.

An evaluation was made of a conventional projection fish-eye type of lens having very low angular distortion. It was observed that when such a lens was used to display star images, such as would be displayed in a planetarium, the stars suffered from degraded image quality near the edges of the field. Specifically, elongated images (coma) and severe color fringing (chromatic) aberration were observed in these regions. In other words, the image of the stars (e.g., the shape of the star) noticeably changed from what would be seen at the zenith (e.g., circular) to what would be observed near the edges of the field or near the horizon (e.g., elongated or hot dog shaped).

It thus would be desirable to provide a new and improved fish-eye type of projection lens that would maintain the image or shape of the object being displayed in high contrast conditions. Such a projection lens also would desirably provide such an image maintaining capability while being capable of display images over a wide range of angles. It would be particularly desirable to provide a projection system embodying such a projections lens and method that would display images in a high contrast conditions. It also would be desirable to provide such a projection system that can be used in combination with conventional portable planetariums.

### SUMMARY OF THE INVENTION

The present invention features a projection lens, more particularly a multi-optical element lens assembly, whose optical elements are configured and arranged so as to minimize angular distortion and so as to also maintain the shape of the images being displayed. Stated another way, the optical elements are arranged and configured so to introduce a predetermined amount of distortion (i.e., intentionally departing from the f-theta condition) that maintains the shape of the images being displayed from the zenith to near the edge of the field of view while minimizing the angular distortion.

A conventional projection lens (e.g., conventional fish-eye lens) is optimized so that every pixel being projected takes up the same angle of the projection. Consequently, when image data is projected onto a hemispherical screen near the edge of the field the shape of the image data becomes distorted. For example, a square shape observed at the zenith position would appear as a rectangular shape when projected near the edge of the field. In contrast, for the projection lens of the present invention in which a predetermined distortion is introduced, the square shape at the zenith also would appear as a square near the edge of the field. As with conventional techniques the projection lens of the present invention would be configured and arranged so as to be defocused slightly so that the image of the stars being projected will appear round rather than elliptical.

Also featured is a digital portable planetarium projection system including a digital projector that can be operably coupled to a microprocessor for the generation of images and a projections lens of the present invention that is optically coupled to the digital projector using any of a number of techniques known to those skilled in the art. The computer generates the image data to be displayed, such as sky data or other educational information, and such image data/information is communicated to the digital projector for display. The image data is outputted through the projection lens of the present invention so as to be displayed on a hemispherical screen.

In further embodiments, the digital projector is a DLP type of projector, although it is contemplated that the projection lens of the present invention can be adapted (e.g., the optical elements making up the projections lens can be adjusted) based on the teachings herein so as to be used in combination with other types of projectors.

Other aspects and embodiments of the invention are discussed below.

### BRIEF DESCRIPTION OF THE DRAWING

For a fuller understanding of the nature and desired objects of the present invention, reference is made to the following detailed description taken in conjunction with the accompanying drawing figures wherein like reference character(s) denote corresponding parts throughout the several views and wherein:

FIG. 1 is a schematic view of a projection system according to the present invention;

FIG. 2 is a perspective view of a projection apparatus according to the present invention;

FIG. 3A is a cross-sectional view of the projection lens assembly according to the present invention;

FIG. 3B is an explode view of the projection lens assembly of FIG. 3A;

FIG. 4 is an illustrative schematic view of the layout of the optical elements of a projection lens assembly according to the present invention;

FIGS. 5A-C provide data summaries of various optical data for an exemplary embodiment of projection lens assembly according to the present invention; and

FIGS. 6A-G are graphical views illustrative of performance of the projection lens assembly of FIGS. 3A, 4.

### DESCRIPTION OF THE PREFERRED EMBODIMENT

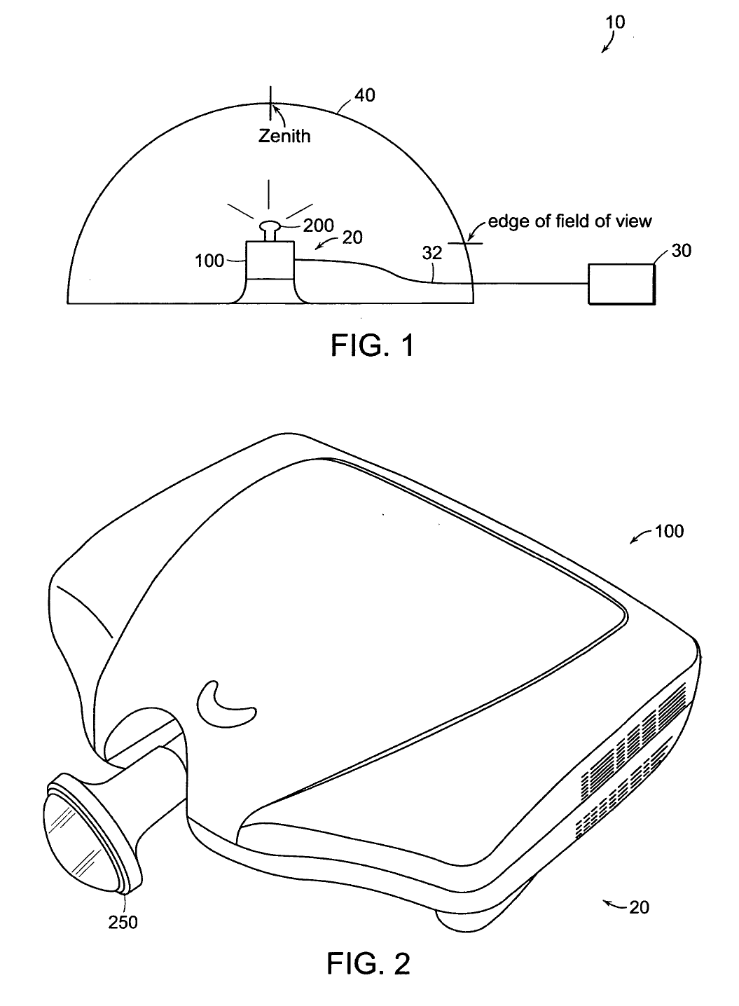

Referring now to the various figures of the drawing, wherein like reference characters refer to like parts, there is shown in FIG. 1 a schematic view of a projection system 10 according to the present invention. Such a system includes a projection apparatus 20, a computer or micro-processing device 30 operably and communicatively coupled to the projection apparatus and a screen 40 on which is displayed the optical output from the projection apparatus.

The screen 40 is any of a number of devices or apparatuses known in the art that can display image data projected thereon by a projection apparatus. In particular embodiments, the screen 40 is a hemispherically shaped screen. Such hemispherical screens can be portable screens (such as an inflatable self-supporting screen as described in U.S. Pat. No. 4,164,829 or the portable projection dome as described in U.S. Pat. No. 5,724,775, the teachings of which are incorporated herein by reference), semi-rigid screens or rigid screens.

The computer or micro-processing device 30 is any of a number of devices known to those skilled in the art by which image data of a desired image or successive image data in a time sequence can be generated and outputted in the appropriate format to the projection apparatus 20. In exemplary embodiments, the micro-processing device 30 is a personal type of computer including an applications program that is executed on the computer. The applications program includes instructions and criteria for generating image data (such as sky data, world geological data) that can either be static or motion image data, and providing outputs of such image data in the appropriate format for causing the projection apparatus to provide an optical output representative of generated image data.

The cable(s) 32 interconnecting the micro-processing device 30 and the projection apparatus 20 comprise(s) any of a number of interconnecting cables known to those skilled in the art. While cable(s) 32 are illustrated, this shall not be considered limiting as it is within the scope of the present invention for the micro-processing device 30 and the projection apparatus 20 to be communicatively and operably coupled using any of a number of wired, optical or wireless techniques. Such techniques also include communications via wireless, wired or optical networks such as for example a local area network (LAN) or wide area network (WAN). For example, the image data can be generated from a sever, transmitted via a network to a workstation that is operably connected to the projection apparatus.

Referring now also to FIG. 2, the projection apparatus 20 includes a projector 100 and a projection lens 200. The projector 100 is any of a number of digital projection devices known to those skilled in the art that provides an optical output responsive to input signals from a micro-processing device 30. In particular embodiments, the projector 100 embodies DLP techniques. In exemplary embodiments, the projector 100 is a projector made by Sharp Corporation (e.g., Model XV1200U), which projector includes a DLP chip or microprocessor of Texas Instruments.

Although digital projectors are illustrated, this shall not be considered limiting. It is contemplated and thus, is within the scope of the present invention for other types of projectors to be included with the projection apparatus 20 of the present invention. For example, a slide type of projection device is used in combination with the projection lens 200 of the present invention to form the projection apparatus 20.

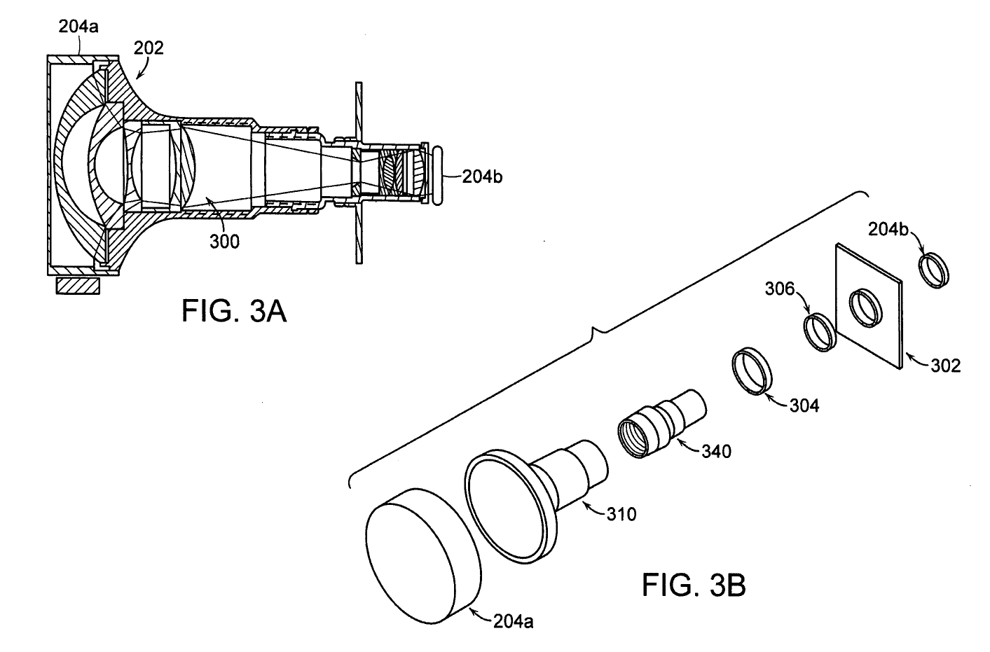

Referring now also to FIGS. 3A, B, the projection lens 200 of the projection apparatus 20 includes a housing 202 and lens assembly 300 that is disposed within the housing. When assembled, the projection lens 200 also can include one or more end caps 204a, b that are affixed to the output end and/or the input end that is optically coupled to the projector 100. The end caps 204a, b are made from any of a number of materials known in the art and appropriate for the intended use.

The housing 202 is configured an arranged so as to provide support for the optical elements making up the lens assembly 300 and so as to provide a light tight enclosure so that light from the environment (e.g., outside the housing 202) does not enter into the light path between the input and output ends of the lens assembly. The housing 202 is constructed of any of a number of materials known to those skilled in the art that provides the support and light tight features has described herein.

In an illustrative embodiment, the lens assembly 300 includes a lens mount 302 as is known to those skilled in the art for securely mounting the lens assembly to the projector 100. More specifically, and as known to those skilled in the art, the lens mount 302 secures the lens assembly 300 to the optical output of the projector. In further illustrative embodiments, the lens assembly 300 includes a focus adjusting ring 304 and a lock nut 306 as is known to those skilled in the art for controllably adjusting the focus of the lens assembly.

The lens assembly 300 comprises a number of optical elements or lenses that are arranged in a particular order and are each configured so the optical images emanating from the lens assembly can be displayed about on a hemispherical type of screen. In more particular embodiments, the optical elements or lenses are arranged so that the lens assembly is generally categorized as a fish-eye type of wide-angle lens. In further embodiments, the optical elements or lenses of the lens assembly 300 are configured and arranged so that the images or pixels being displayed throughout the screen appear symmetrical between the image displayed at the zenith and the image being displayed at near the edge of the field of view (e.g., symmetric pixels at all locations). For example, if the image displayed at the zenith was square in shape, then that same image as it moves from the zenith position to at near the edge of the field of view would remain and/or be perceived by the viewer as being a square.

In yet further embodiments, the optical elements or lenses are configured and arranged so that a predetermined distortion is introduced so that the images at the zenith and near the edge of the field are perceived to be substantially similar in shape. In other words, the optical elements of the lens assembly 300 of the present invention are arranged and configured so as to depart from the linear condition of f-theta condition normally associated with conventional fish-eye type of wide-angle lens. Also, the optical elements or lenses are configured and arranged so as to also minimize angular distortion. In other words, the optical elements or lenses are preferably configured and arranged so as to optimize the symmetry of the image shape at all display locations on the screen and minimize angular distortion.

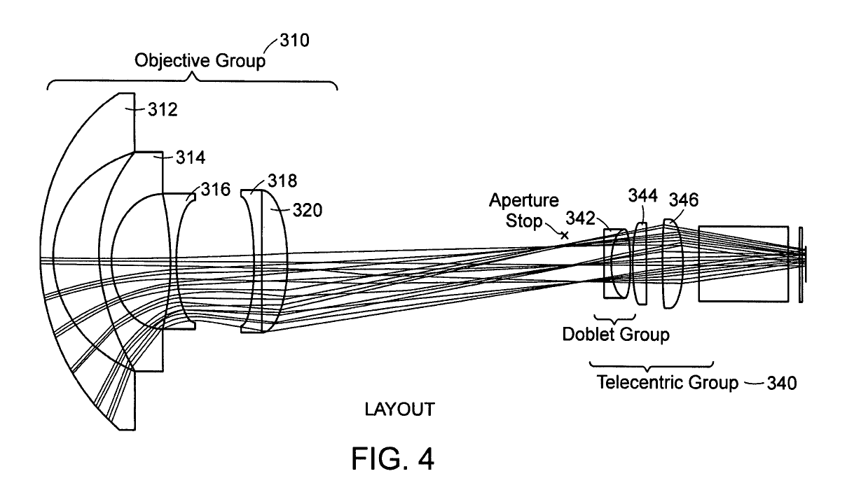

Referring now also to FIG. 4, the lens assembly 300 according to an illustrative, exemplary embodiment of the present invention comprises a five-element objective group 310 or wide-angle lens and a three-element telecentric group 340. The first element 312 of the objective group 310 is a negative meniscus lens and the second element 314 of the objective group is a negative meniscus lens. The third element 316 of the objective group 310 is a negative lens and the fourth element 318 of the objective group is a negative lens that is bi-concave. The fifth element 320 of the objective group is a positive lens that is bi-concave. The first element 342 of the telecentric group 340 is a doublet group, the second element 344 of the telecentric group is a positive meniscus lens and the third element 346 of the telecentric group is a positive lens that is bi-concave.

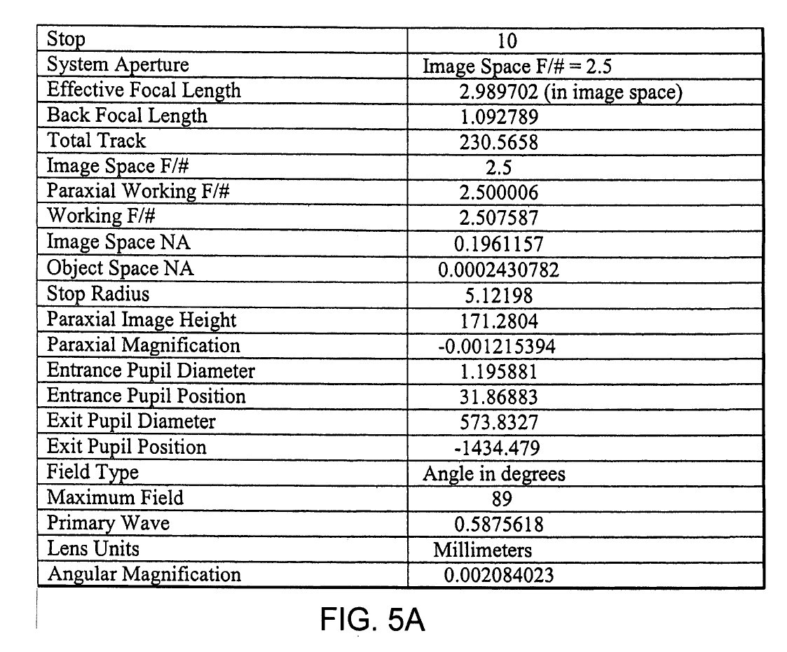

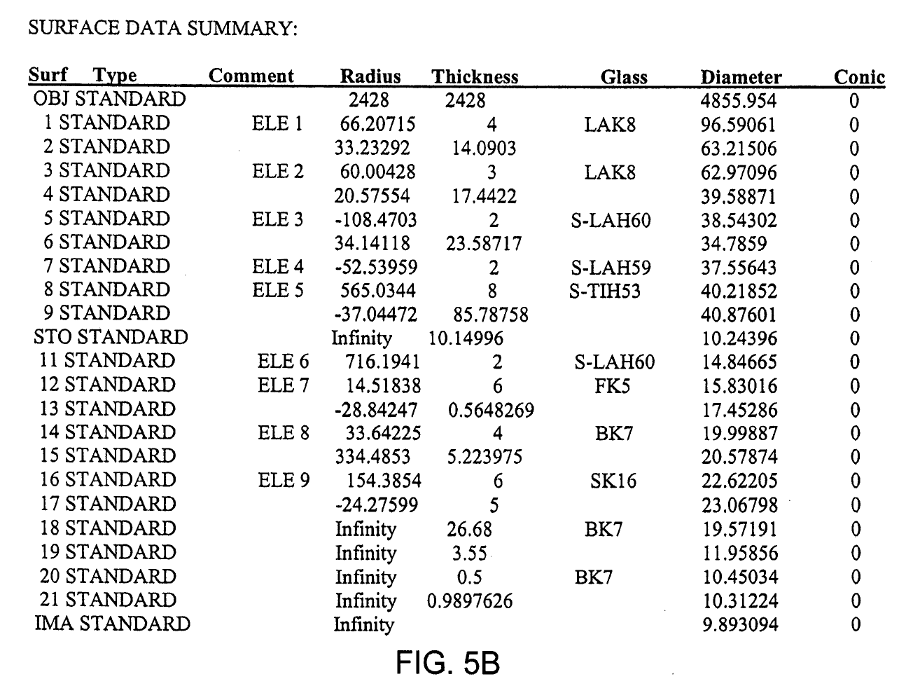

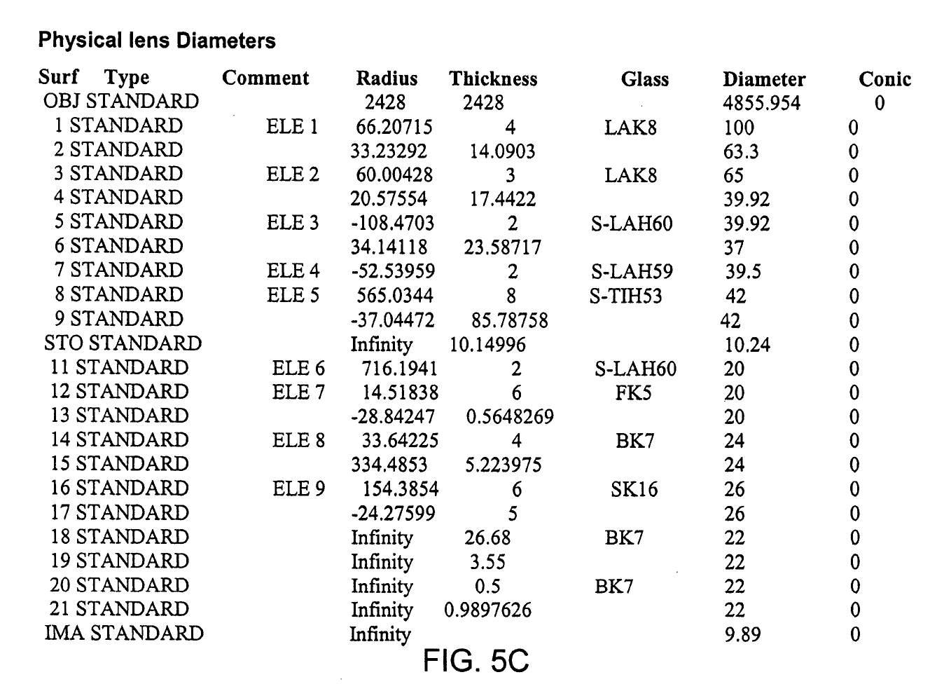

The structural and optical characteristics/parameters of the optical elements of the exemplary illustrative embodiment of the lens assembly 300 according to the preset invention are provided in FIGS. 5A-C. It should be recognized that such parameters/characteristics are illustrative and that it is within the skill of those knowledgeable in the art to adapt the teaching herein so as to yield lens assemblies having a different number of optical elements or lens assemblies with optical elements having differing optical characteristics or parameters while achieving the functions or results of the present invention. In other words, such a lens assembly would be such as to control the shape of the image being displayed as it was moved from the zenith to at the near the edge of the field of view(e.g., maintain the shape or the perceived shape of the image being displayed).

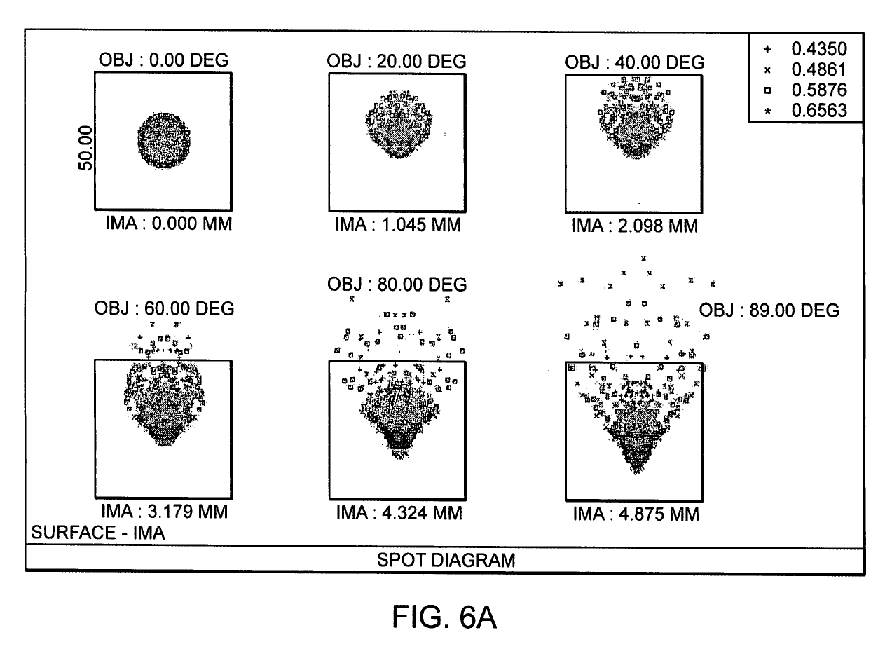

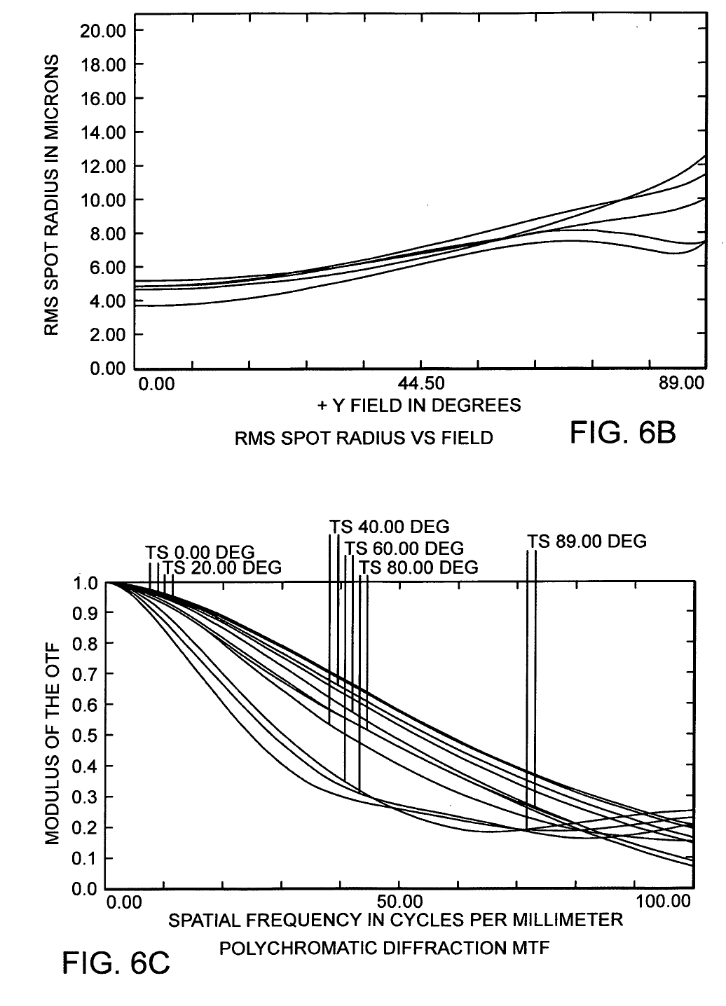

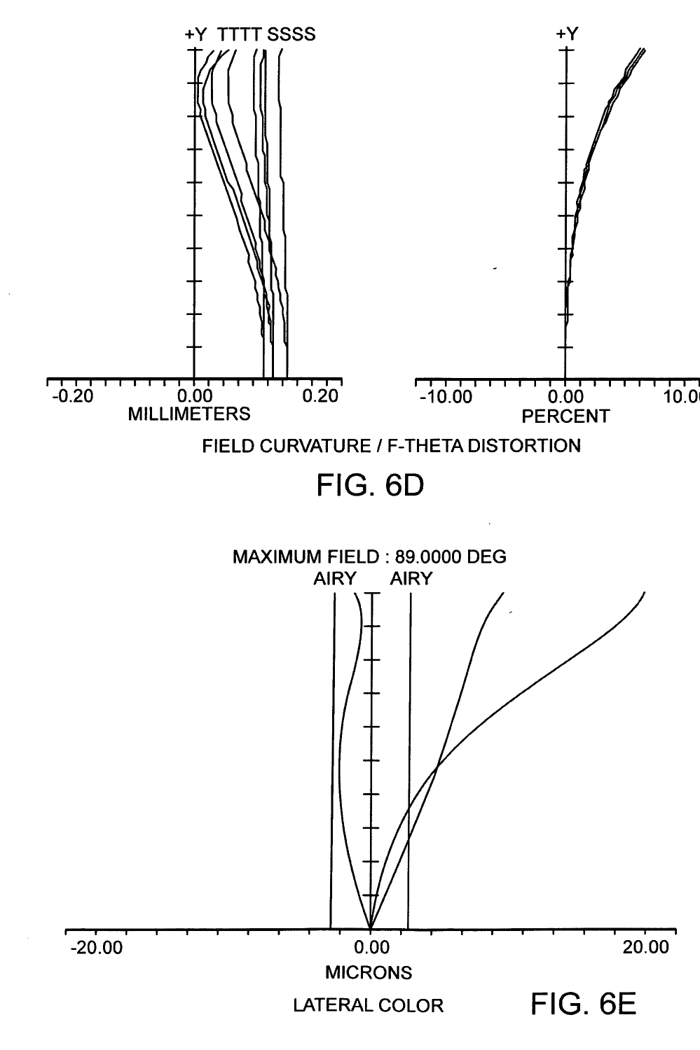

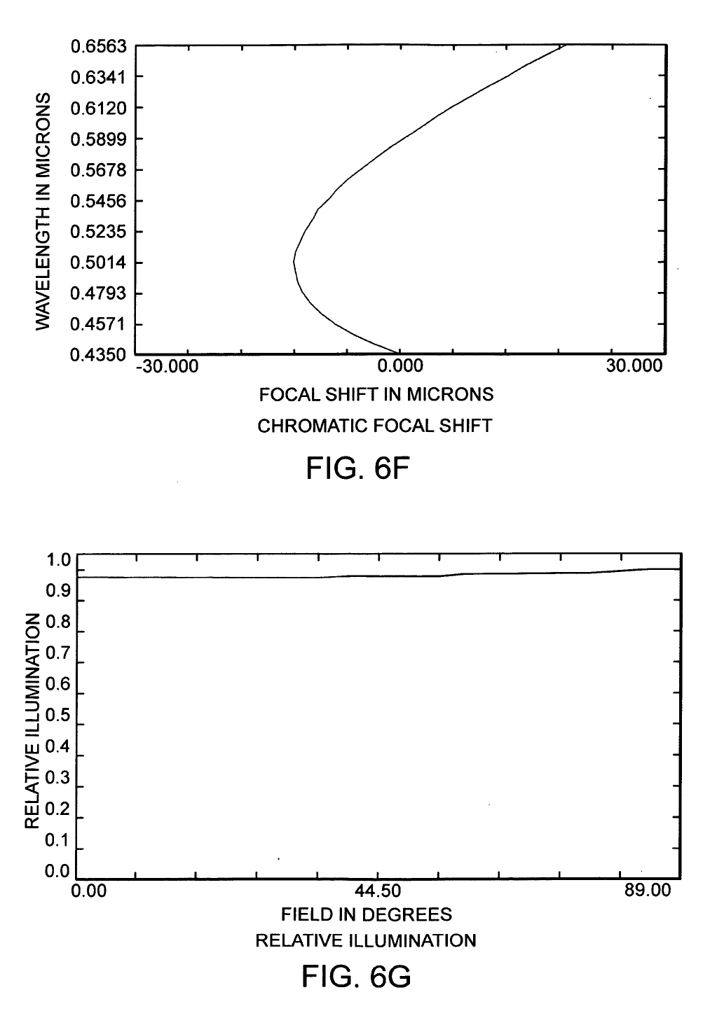

There also are provided in FIGS. 6A-G various graphical views illustrating the performance of a projection apparatus 20 that embodies the exemplary illustrative embodiment of a lens assembly 300 of the present invention.

It should be recognized that that the arrangement, number and kinds of optical elements being shown is illustrative and shall not be considered limiting. For example, the illustrated lens assembly 300 is configured so as to provide an inline arrangement of the input and output ends of the lens assembly. In further embodiments, the lens assembly is arranged so that the output end is at an angle with the input end of the lens assembly. In this way the projector 100 would be arranged so its optical output is oriented at an angle with respect to the output end of the lens assembly.

Although a preferred embodiment of the invention has been described using specific terms, such description is for illustrative purposes only, and it is to be understood that changes and variations may be made without departing from the spirit or scope of the following claims.

Incorporation by Reference

All patents, published patent applications and other references disclosed herein are hereby expressly incorporated by reference in their entireties by reference.

### Equivalents

Those skilled in the art will recognize, or be able to ascertain using no more than routine experimentation, many equivalents of the specific embodiments of the invention described herein. Such equivalents are intended to be encompassed by the following claims.

What is claimed is:

1. A projection lens for use in projecting images onto a hemispherical screen, said projection lens comprising:
a plurality of optical elements;
wherein the optical elements are configured and are arranged so that such configuration and arrangement corrects for distortion of the shape of an image being displayed on the screen between the zenith and at near the edge of the field of view.

2. The projection lens of claim 1 wherein the edge of the field of view is at a position corresponding to at or about 90 deg from the zenith.

3. The projection lens of claim 1, wherein the optical elements are configured and arranged so as to depart from the linear condition of f-theta.

4. The projection lens of claim 1, wherein the optical elements are configured and arranged so that such configuration and arrangement introduces image distortion that yields more symmetric pixels between the zenith and at near the edge of the field of view.

5. The projection lens of claim 1, wherein the optical elements are configured and arranged so that such configuration and arrangement introduces a predetermined amount of distortion that substantially maintains the shape of the images being displayed on the hemispherical screen from the zenith to near the edge of the field of view.

6. The projection lens of claim 2, wherein the optical elements are configured and arranged so as to depart from the linear condition of f-theta.

7. The projection lens of claim 2, wherein the optical elements are configured and arranged so that such configuration and arrangement introduces image distortion that yields more symmetric pixels between the zenith and at near the edge of the field of view.

8. A projection apparatus for projecting images onto a hemispherical screen, said projection apparatus comprising:
a projector having a light output;
a lens assembly optically coupled to the projector's light output;
wherein the lens assembly includes a plurality of optical elements; and
wherein the optical elements are configured and are arranged so that such configuration and arrangement corrects for distortion of the shape of an image being displayed on the screen between the zenith and at near the edge of the field of view.

9. The projection apparatus of claim 8 wherein the edge of the field of view is at a position corresponding to at or about 90 deg from the zenith.

10. The projection apparatus of claim 8 further comprising:
a micro-processing device operably coupled to the projector, the micro-processing device generating and outputting image data to the projector, which image data being displayed by the projector.

11. The projection apparatus of claim 8, wherein the optical elements of the lens assembly are configured and arranged so as to one of depart from the linear condition of f-theta, so that such configuration and arrangement introduces image distortion that yields more symmetric pixels between the zenith and at near the edge of the field of view or so that such configuration and arrangement introduces a predetermined amount of distortion that substantially maintains the shape of the images being displayed on the hemispherical screen from the zenith to near the edge of the field of view.

12. A projection system, comprising:
a projector having a light input;
a hemispherical screen;
a lens assembly optically coupled to the projector's light output;
wherein the lens assembly includes a plurality of optical elements; and
wherein the optical elements are configured and are arranged so that such configuration and arrangement corrects for distortion of the shape of an image being displayed on the hemispherical screen between the zenith and at near the edge of the field of view.

13. The projection system of claim 12 wherein the edge of the field of view is at a position corresponding to at or about 90 deg from the zenith.

14. The projection system of claim 12 further comprising:
a micro-processing device operably coupled to the projector, the micro-processing device generating and outputting image data to the projector, which image data being displayed by the projector onto the screen.

15. The projection system of claim 12, wherein the optical elements of the lens assembly are configured and arranged so as to one of depart from the linear condition of f-theta, so that such configuration and arrangement introduces image distortion that yields more symmetric pixels between the zenith and at near the edge of the field of view or so that such configuration and arrangement introduces a predetermined amount of distortion that substantially maintains the shape of the images being displayed on the hemispherical screen from the zenith to near the edge of the field of view.

16. A planetarium projection system, comprising:
a projector having a light output;
a hemispherical screen;
a lens assembly optically coupled to the projector's light output;
wherein the lens assembly includes a plurality of optical elements; and
wherein the optical elements are configured and are arranged so that such configuration and arrangement corrects for distortion of the shape of an image being displayed on the hemispherical screen between the zenith and at near the edge of the field of view.

17. The planetarium projection system of claim 16, wherein the edge of the field of view is at a position corresponding to at or about 90 deg from the zenith.

18. The planetarium projection system of claim 16, further comprising:
a micro-processing device operably coupled to the projector, the micro-processing device generating and outputting image data to the projector, which image data being displayed by the projector onto the screen.

19. The planetarium projection system of claim 16, wherein the optical elements of the lens assembly are configured and arranged so as to one of depart from the linear condition of f-theta, so that such configuration and arrangement introduces image distortion that yields more symmetric pixels between the zenith and at near the edge of the field of view or so that such configuration and arrangement introduces a predetermined amount of distortion that substantially maintains the shape of the images being displayed on the hemispherical screen from the zenith to near the edge of the field of view.
